(19) United States
(12) Patent Application Publication
(10) Pub. No.: US 2006/0063130 A1
(43) Pub. Date: Mar. 23, 2006

(54) Dental instruments with stress relief

(75) Inventors: Robert Hayman, Los Angeles, CA (US); Ken Rosenblood, Los Angeles, CA (US)

Correspondence Address: DISCUS DENTAL IMPRESSIONS, INC., 8550 HIGUERA STREET, CULVER CITY, CA, 90232, US

(73) Assignee: Discus Dental Impressions, Inc.

(21) Appl. No.: 11/230,712

(22) Filed: Sep. 19, 2005

Related U.S. Application Data
(60) Provisional application No. 60/612,283, filed on Sep. 21, 2004.
(60) Provisional application No. 60/612,006, filed on Sep. 21, 2004.
(60) Provisional application No. 60/624,833, filed on Nov. 3, 2004.
(60) Provisional application No. 60/624,840, filed on Nov. 3, 2004.

(51) Int. Cl. A61C 3/00

(52) U.S. Cl. 433/141

(57) ABSTRACT

The present invention relates to a unique solution for relieving repetitive stress to dental professionals during the course of a day and is directed to sets of identical instruments, having handles made with varying diameters for grasping, designed to be used interchangeably throughout the day, thus cutting down on the repetitive grasping action through the change of grasp. Therefore, even if a dental professional uses the same type of instrument throughout the day, the hands, wrists and elbows can experience varying rather than repetitive action because the positioning of the hands, wrists and elbows are interchanging throughout the day. The dental instrument may also be ergonomically designed. Additionally, the instrument may also have a vibratory module. Further, a rotator may also be implemented.

### CROSS-REFERENCE TO RELATED APPLICATIONS

This application claims the benefit of U.S. provisional patent applications: Ser. No. 60/612,283 entitled “Dental Tool Having A Durable Coating” filed on Sep. 21, 2004; 60/612,006 entitled “Dental Instruments Having Durable Coatings” filed Sep. 21, 2004; 60/624,833 entitled, “Dental Instrument” filed on Nov. 3, 2004; and 60/624,840 entitled, “Dental Instruments With Stress Relief” filed on Nov. 3, 2004; the contents of all are hereby incorporated by reference.

This application is related to the following U.S. patent applications: 11/______, entitled “Dental Instruments” to be concurrently filed; and 11/______, entitled “Dental Instruments Having Durable Coatings” to be concurrently filed; the contents of both are hereby incorporated by reference.

### FIELD OF THE INVENTION

The present invention relates to dental instruments having handles for grasping by the dental professionals. In particular, the present invention relates to handheld dental instruments having handles with varying diameters for grasping by dental professionals.

### BACKGROUND OF THE INVENTION

The dental instruments a dental professional used during a day all have handles or grasping portions that are of approximately the same diameter, even on different instruments. Repetitive use of the instruments during the day causes repetitive stress to the hands, wrists, and elbows. This can lead to carpal tunnel syndrome (CTS) and cumulative trauma disorder (CTD) among dental hygienists, dentists and other dental professionals.

One way of relieving such stress maybe to have handles that are designed more ergonomically. However, such ergonomically designed handles can still cause repetitive action. Thus, there remains a need for a dental instrument that can help to relieve repetitive stress.

### SUMMARY OF THE INVENTION

The present invention relates to a unique solution for relieving repetitive stress to dental professionals during the course of a day.

The present invention includes sets of identical or different instruments, having handles made with varying diameters for grasping, designed to be used interchangeably throughout the day, thus cutting down on the repetitive grasping action through the change of grasp. Therefore, even if a dental professional uses the same type of instrument throughout the day, the hands, wrists and elbows may experience varying rather than repetitive action because the positioning of the hands, wrists and elbows are changing throughout the day. Each of the dental instruments includes an elongated housing having an interior that is solid, hollow or partially solid. The elongated body has a distal end and a proximal end with a portion of which serving as a handle for grasping by the dental professional. At least one dental tip extends therefrom, and removably connects to one end of the housing.

The present invention further includes sets of identical instruments having ergonomically designed handles made with varying diameters for grasping, designed to be used interchangeably throughout the day. Coupled with more ergonomically designed handles, they can go a long way to relieving stress to the hands, wrists and elbows of dental professionals.

The present invention also relates to sets of identical instruments having handles made with varying diameters for grasping, designed to be used interchangeably throughout the day, including a battery powered vibratory module.

A vibrator module may be positioned and supported inside the at least partially hollow portion of the housing towards the distal end, the proximal end or both ends of the body. The module has a small motor for rotating an eccentric weight to cause a vibration of the tip. A battery may be positioned inside the housing to power the vibrator module to excite the vibratory element. The battery may be disposable or rechargeable.

The vibration may be generated by a small motor rotating an eccentric weight to cause a vibration of the instrument, for example, the tip and/or the handle. This vibratory action exerts a massage action on the hands of the dental professional, further contributing to stress relief.

The motor support is adapted to optimize the coupling of mechanical vibrations between a housing of the motor and the handle. The handle may also be ergonomically designed.

The present invention further relates to sets of identical instruments including handles with varying diameters for grasping, said handles having distal ends and proximal ends, the distal ends having at least a cone-shaped portion permanently attached or removably attached to the distal ends with its wider end, and dental tips extending from the narrower ends. The dental tips may be permanently attached or removably attached to the narrower ends of cone-shape portions. The cone-shaped portion may be adapted for rotation wherein such rotation also rotates the dental tip so that the tip may be easily repositioned without being taken out of the patient's mouth.

In one aspect, the cone-shape portions have hollow bodies and a vibrator module may be positioned and supported inside the hollow body of each of the cone-shape portions. The vibrator module has a small motor for rotating an eccentric weight to cause a vibration in the tip and/or along the handle. A battery may be positioned inside the hollow handle to power the vibrator module to excite the vibratory element. The battery may be disposable or rechargeable.

A further aspect of the invention relates to at least a removable cone-shaped portion or collar for attaching the tip to the handle.

In addition, each of the instruments described above may also be made with an anti-rotation means for preventing said vibrator module from rotating relative to said housing when said vibratory tool is in use.

The tips or handles of the instruments may also be coated with a flexible and durable coating coated thereon, such that the coated tip may be bent to the desired configuration, is disclosed. The coating includes a diamond-like-carbon (DLC) coating including at least about 5 atomic percent of hydrogen.

In one aspect, the tip may be bent to any desired configuration after coating, such bending action does not substantially affect the integrity of the coating adversely.

In another aspect, the coating may be performed on the tip after bending.

### BRIEF DESCRIPTION OF THE FIGURES

FIG. 1 shows a perspective view of a set of dental instruments with varying handle diameters;

FIG. 2 shows a perspective view of a set of ergonomically designed dental instruments with varying diameters;

FIG. 3 shows a perspective view of an instrument fitted with a vibrator;

FIG. 4 shows a side view of an ergonomically designed dental instrument according to one aspect of the invention;

FIG. 5 shows a perspective view of an instrument of FIRG. 1 or 2 fitted with a vibrator;

FIG. 6 shows a perspective of another ergonomically designed dental instrument of the present invention including a rotatable tip;

FIG. 7 shows a perspective view of a method of gripping one any one of the instruments in FIG. 1;

FIG. 8 shows a perspective view of a method of gripping one any one of the instruments in FIG. 2;

FIG. 9 shows a block diagram of a dental instrument including a self-contained vibratory mechanism;

FIG. 10a shows a cutaway view of an active dental instrument according to one embodiment of the invention; an

FIGS. 10b-10d show various elliptical loads for an active dental instrument according to respective embodiments of the invention;

FIG. 11 shows an exploded view of an active instrument having a rotator head; and

FIG. 11a shows a hand grip adapted for fitting onto an active instrument.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the steps for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention.

Repetitive action on the hand, wrist and elbows during the day can lead to carpal tunnel syndrome (CTS) and cumulative trauma disorder (CTD) among dental hygienists, dentists and other dental professionals, as noted above. Even ergonomically designed handles can only relieve such stress up to a certain extent. The present invention relates to a better way of releasing the stress by reducing the repetitive action during the day.

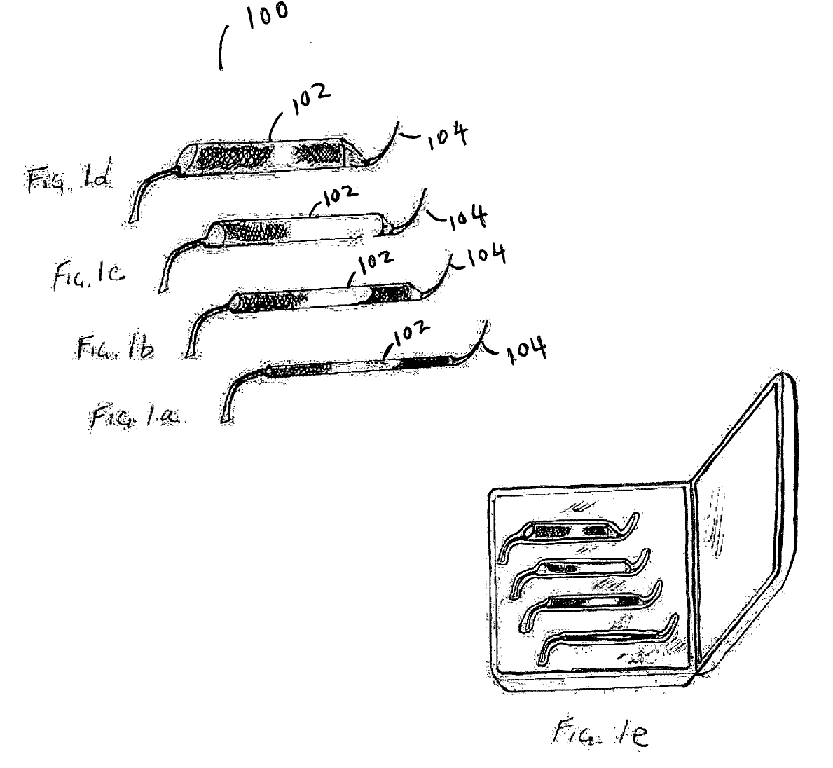

FIGS. 1a-d show a set of dental instruments, such as a dental scaler 100, according to one embodiment of the invention. As shown, each of the instruments includes a handle portion 102 and a tooth contacting portion 104. In the illustrated embodiment, the tooth contacting portion 104 is a scaler tip.

The handle portion 102 is cylindrical and may be of a solid core, a hollow core, or a partially hollow core, having a distal end and a proximal end. As an illustration, the diameters of the handles vary from FIG. 1a to 1d. In other embodiments, a series with different numbers of handles with varying diameters is contemplated. The sets of identical instruments made with varying diameters for grasping, can cut down on the repetitive action. Thus, even if the dental professional use the same type of instrument throughout the day, the hands, wrists and elbows can experience varying rather than repetitive action because the positioning of the hands, wrists and elbows are changing throughout the day.

The handle 102 may be tapered toward either the distal end, the proximal end, or both, and extending from the tapered end or ends are the dental tips adapted to be used on a patient's teeth or tooth.

The dental tip may be a scaler, as shown, or any other adapted to be fitted into a handheld instrument of the present invention, for example, a reamer, an endodontic file, a dental file or bur.

As noted, the dental tip may be present on both the distal end and the proximal end of the instrument (not shown) or it may be present on only one end.

The handle 102 may be made of metal or plastic. The cone-shaped portion or tapered portion 114 or the collar 604 may be made of the same or different material from the rest of the handle. A suitable metal may include stainless steel, titanium, titanium alloys such as nickel-titanium and titanium-aluminum-vanadium alloys; aluminum, aluminum alloys; tungsten carbide alloys and combinations thereof. A non-metal may include reinforced or unreinforced polymers such as, for example, polyamide (nylon); ultrahigh molecular weight polyethylene (UHMWP); Polyacetyl (Delrin); Polyaramid (Kevlar) ; ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198 the contents of which are incorporated herein by reference), polyesterimide anhydrides with terminal anhydride group or lateral anhydrides (exemplified in U.S. Pat. No. 6,730,377, the content of which is incorporated herein by reference)or combinations thereof.

In addition, any polymeric composite such as engineering prepegs or composites, which are polymers filled with pigments, carbon particles, silica, glass fibers, conductive particles such as metal particles or conductive polymers, or mixtures thereof may be used.

Likewise, the tip may also be either made of metal or plastic and the same or similar material suitable for the handle portion are also suitable for the tip. As noted above, the tip may also be in the form of a scaler, and endodontic file, a reamer, a dental file or a bur.

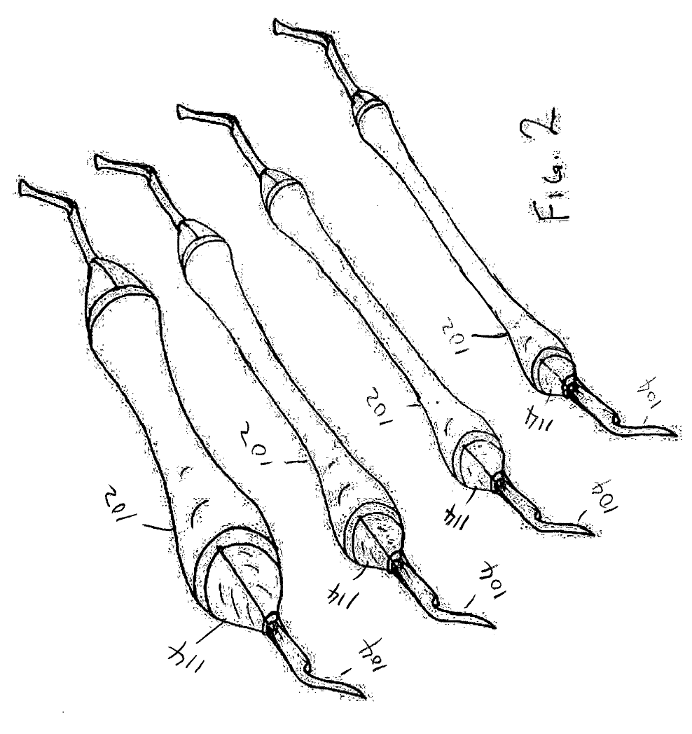

As noted, the set of instruments show in FIGS. 1a-d are identical, except for the diameters of the handles 102. This is also illustrated in FIG. 2, where the handles 102 are of ergonomic design. The identical instruments with varying diameter handles may be used interchangeable throughout the day. Combining the varying diameters with the more ergonomically designed handles, the handles can a long way in relieving stress to the hands, wrists and elbows of dental professionals.

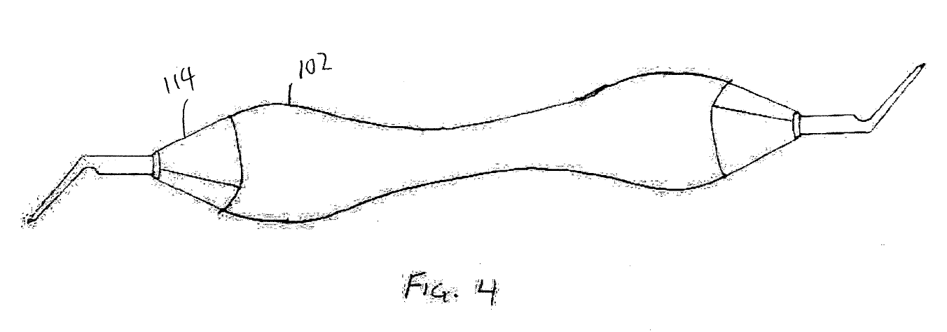

At least the portion of the ergonomic handle. 102 may have a triangular cross-section, as shown in FIGS. 2, 4 or and 5 with a mid-section of a smaller circumferential distance than the gripping areas when the tip 104 is present on both ends. It may also be rounded in the mid-section. This, along with a hollow or partially hollow interior, and the choice of materials can reduce the weight of an instrument to also cut down on fatigue.

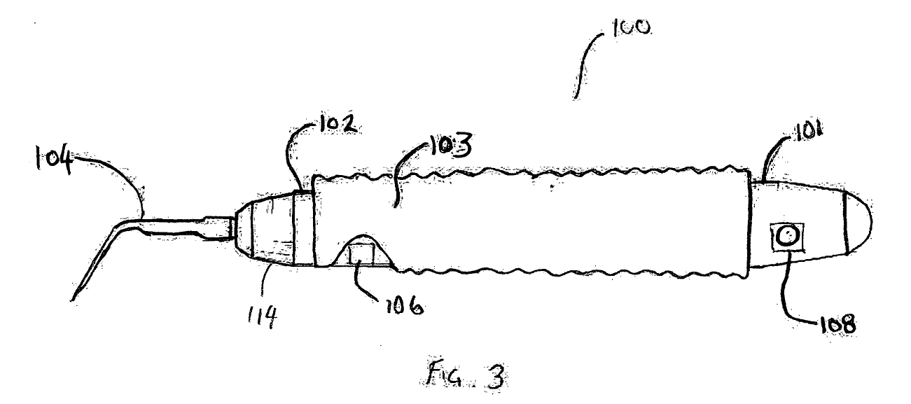

According to one aspect of the invention, a vibrational mechanism may be included within the handle portion 102, as shown in FIG. 3. The vibrational mechanism is adapted to induce oscillatory vibrations of an outer surface 101 of the handle 102, or a portion thereof. The oscillatory vibrations may include a variety of oscillatory modes including flexural and elastic linear modes and rotational modes.

According to one embodiment of the invention, as exemplified in FIG. 3, the instrument 100 includes a resilient material 103 disposed on the outer surface 101 of the handle 102. The resilient material 103 serves to cushion the grip of the dental professional during application of the instrument.

The resilient material may be either a natural or synthetic rubber. Synthetic rubbers may be, for example, elastomeric materials and may include, but not limited to, various copolymers or block copolymers (Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above.

According one aspect, the invention includes a switching device 106 supported by the handle portion 102. The switching device 106 allows a user to activate, and deactivate, the vibrational mechanism disposed within the handle portion 102, as shown in FIG. 3.

The vibrational mechanism impart vibration to the tips which can come into contact with the patient's teeth to either remove, or aid in the removal of, for example, plaque and calculus, by reducing the amount of force needed. Surprisingly, the vibrational action also imparts a vibration to the handle, resulting in a massaging action to the hands, wrists and elbows of the user, further contributing to the stress relief. The details of the vibratory instrument is described in U.S. provisional application No. 60/624,833 entitled “Dental Instrument” filed on Nov. 3, 2004; and U.S. patent application Ser. No. 11/______, entitled “Dental Instrument”, to be concurrently filed; the contents of both are hereby incorporated by reference.

According to the illustrated embodiment of the invention, as exemplified in FIG. 3, an energy port 108, such as a plug receptacle, is supported by the handle portion 102. Energy such as electrical energy, maybe received through the energy port and stored within the handle portion 102 of the dental instrument.

FIG. 4 shows another embodiment of the present invention where the ergonomic design may have a generally cylindrical body 102 and a triangular tapered portion 114 on both ends. A tip extends from both tapered portions 114 of the handle 102.

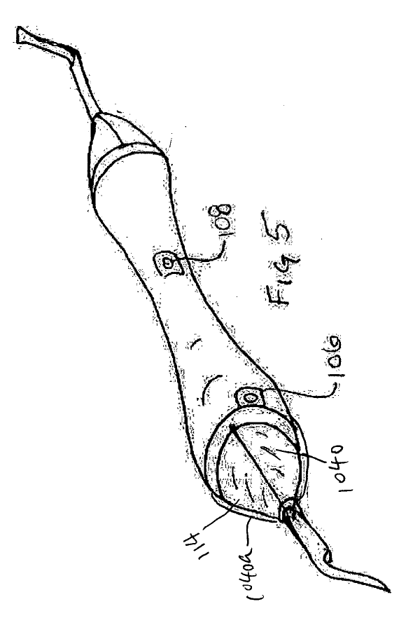

FIG. 5 shows an embodiment of FIG. 1 or 2, including at least one vibration mechanism positioned inside the handle 102. The switching device 106 activates or deactivates the vibration mechanism, as discussed above. The tapered portion 114 may be triangular in shape, as shown here in FIG. 5.

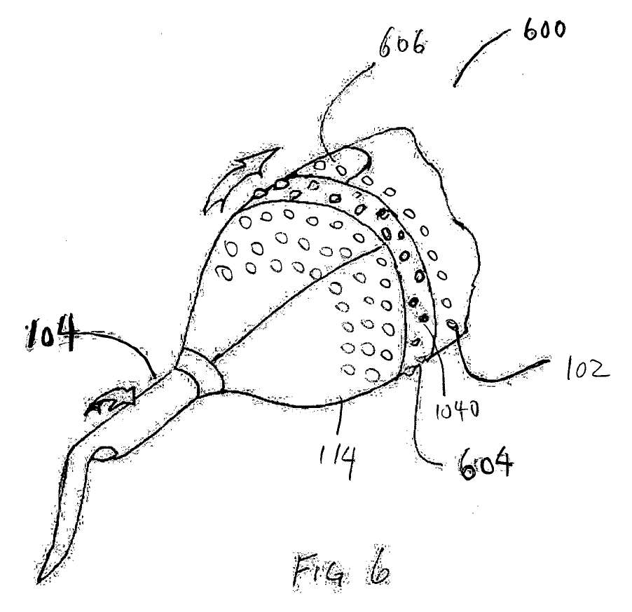

For example, bumps and/or striations 1040, as shown in FIG. 5 or 6, and/or other means, may also be formed on the gripping portion of the handle 102 for better non-slip grip.

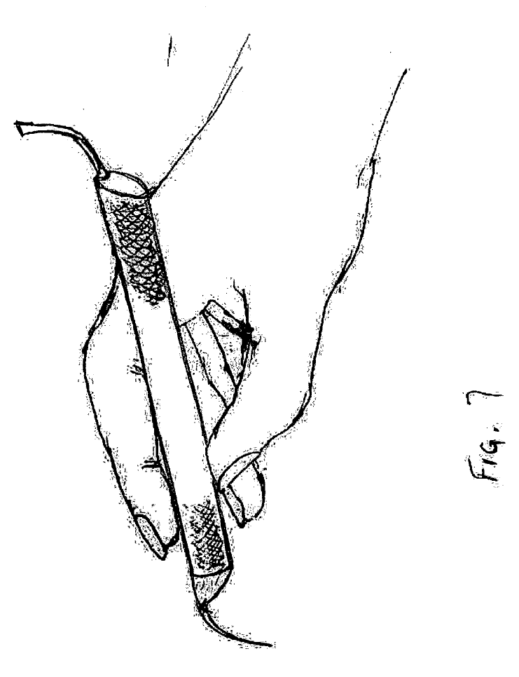

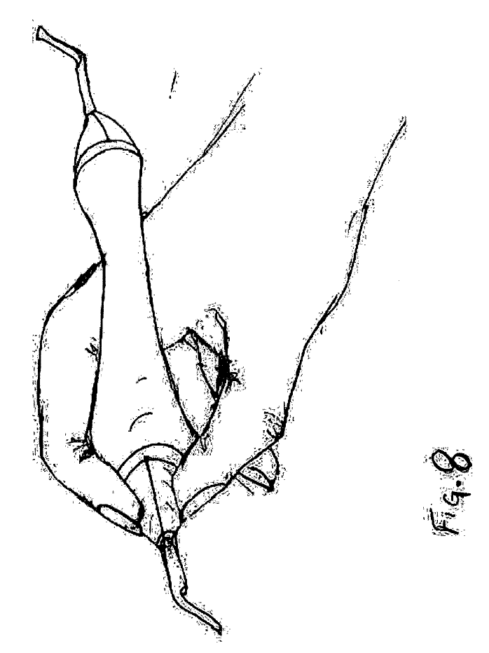

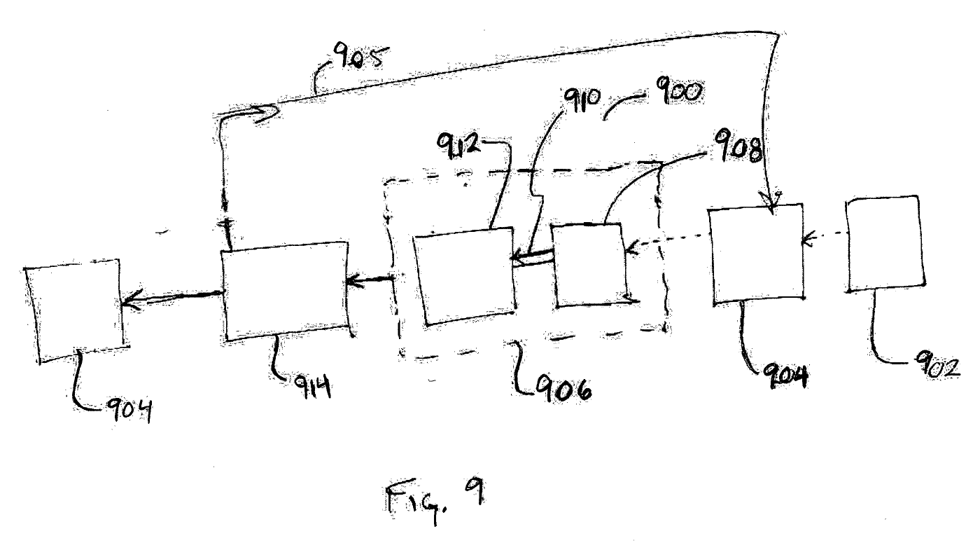

In some embodiments, instead of or in addition to bumps and striations, the handle may also be made with a hand grip 1040a, as exemplified in FIG. 5a, which may be a sleeve-type construction for fitting over a portion of the handle to also facilitate the gripping of the instrument during use, as also illustrated in FIG. 7 or 8. In the embodiment as shown in FIG. 3 as 103, the hand grip is present over a large portion of the handle 102. Such hand grips are generally resilient and of a high temperature resin suitable for autoclaving or heat sterilization process, including those polymers and composites described above that are suitable for the construction of the polymeric tips. In fact, any high temperature resin that can withstand autoclaving may be used.

The hand grip 103 or 1040a may be fabricated from any of the resilient materials mentioned above, a thermoplastic elastomer such as SANTOPRENE® available from the Monsanto Company, or those used in the construction of some tips, as mentioned before. The hand grip 103 or 1040a may be formed through injection molding in some embodiments. In other embodiments, the hand grip 103 or 1040a may be a one-piece construction. In still other embodiments, multi-piece hand grips may be used. By way of an example, a two-piece handgrip may be ultrasonically welded together over the handle 102 or 802. The hand grip 103 or 1040a may have a generally cylindrical shape, as shown in FIG. 3, or may shape like a pistol, as shown in FIG. 11a as 1120.

The hand grip may also be any of the resilient materials mentioned above.

The tapered portion 114, as exemplified in FIG. 2, 5 or 6, may be integrally constructed as part of the handle 102 or it may be constructed separately and then by either molding, brazing, threadably connected or any other type of attachment to attach itself to the rest of the handle 102. The tip 104 may also be permanently or detachably connected to the tapered portion 114 of either the distal or the proximal end-of the handle 102.

The tapered portion 114 may further be a cone-shaped portion 114, for example, having a hollow interior, or at least part of the tapered portion 114 may have a collar 604, as shown in FIG. 3, 6 or 11.

The cone-portion or tapered portion 114, or collar 604, if removable, may be made of a plastic material even if the rest of the handle is made of a metal or metal alloy.

FIG. 6 shows an active instrument 600 having a rotatable tip 104, fixedly or removably coupled to a collar or rotator head 604 of the tapered portion 114. Rotation of the collar or rotator head 604 also rotates the dental tip 104 so that the tip may be easily repositioned without being taken out of the patient's mouth. A detent mechanism prevents rotation of the collar and tip when such rotation is not desired. The detent mechanism may be released to allow rotation by, for example, pressing a release button 606. The mechanism for rotation is similar to that described in the patent application U.S. Ser. No. 10/735,050, incorporated herein by reference.

The cone-portion or tapered portion 114, if remvable, is, for example, made of a plastic material even if the rest of the handle is made of a metal or metal alloy.

As shown in FIGS. 6 and 11, the rotator head 604 located at a distal end of the handpiece 600 is rotatably coupled to the rest of the handpiece 600. The rotator head 604 may have a generally cylindrical shape, a hollow interior, and an opening at each end of the interior, which is used to receive the distal end of the body 102 at one end and a dental tip 104 at the other end. For example, at its distal end, the rotator head 604 has formed thereon an opening 911 for receiving a tip 104.

The rotator head 604 may have formed around its outer peripheral surface a plurality of indentations 910. Each indentation 910 may have an elongated elliptical (or rectangular) shape with its major axis in the direction parallel to the central axis of the handpiece 600. The indentations 910 facilitate grasping of the rotator head 604 by a dental practitioner to rotate it, for example, with respect to the body 102 (e.g., using only one hand). In other embodiments, the rotator head 604 may have a number of protrusions formed thereon instead of the indentations.

The body 102 has formed thereon a pair of grooves 1030 that are equidistant from the top and traverse substantially the whole length of the body 102. The grooves 1030 may be used to mount a hand grip 1120, as shown in FIG. 11, on the handpiece 600. The body 102 may have also formed thereon at its bottom near the distal end of the body 102, a plurality of substantially evenly spaced slots 1080 that may be used to keep the hand grip 1120 from moving in the direction of the axis of the handpiece 600. The body 102 may also have formed thereon at its bottom near the proximal end a groove (not shown) that is co-linear to the slots 1080. The groove may engage the hand grip 1120 together with the grooves 1030 to keep the hand grip 1120 from rotating about the central axis of the handpiece 600.

The hand grip 1120 has an engagement portion 1140, which has a generally cylindrical shape and a hollow interior, as exemplified in FIG. 11a. The engagement portion 1140 is adapted to be slipped onto the body 102, similar to a sleeve, and engages the body 102 such that the engagement portion envelopes a portion of the body 102. The engagement portion may have formed thereon a resilient cantilever portion (not shown), which may be used to engage one of the slots 1080 on the body 102. The engagement portion 1140 may have attached to its bottom surface a handle 1160, which may be grasped by a dental practitioner to hold the handpiece 600 during dental procedures. The handle 1160 may also facilitate rotating of the rotator head 604 using one hand. The handle 1160 may have formed on its back surface a plurality of indentations or protrusions 1200, which are used to facilitate grasping by a dental practitioner.

Referring now to FIGS. 6 and 11, the handpiece 600 further includes a retainer ring 1300, which may be made of metal, for example any of those mentioned above. The retainer ring 1300 may be substantially circular in shape, but does not quite form a complete circle. The retainer ring 1300 may be flexible or resilient and works as a spring in that the ends that are not connected together may be brought closer together by applying pressure, and separate when the pressure is removed.

The rotator head 604 may have formed on the inner surface near its proximal end a circular groove 1310, as exemplified in FIG. 11, that may be used to engage the retainer ring 1300. The retainer ring 1300 may be installed in the circular groove 1310, for example, by applying pressure on the retainer ring 1300 to compress it, and releasing it once the retainer ring 1300 has been aligned with the groove 1310. Upon installation, the retainer ring 1300 is locked to and is fixed with respect to the rotator head 604.

After locking the retainer ring 1300 to the groove 1310, the rotator head 604 is coupled with the body 1020 by receiving the distal end of the body 102 into the rotator head opening at its proximal end. The body 102 may have formed at its distal end an engagement portion 1090, which has a radius that is smaller than the radius of the rest of the body 102. At a joint between the engagement portion 1090 and the rest of the body 102 may be formed a circular groove 1500 on an outer surface of the engagement portion 1030. When the engagement portion 1090 is inserted into the rotator head 604, the retainer ring rotatably engages the groove 1500 such that the rotator head 604 is rotatably coupled to the body 102. In other embodiments, the retaining ring may be fixedly coupled to the body 1020 and rotatably coupled to the rotator head 604.

The hand grips may also be made with varying diameters for grasping, designed to be used interchangeably throughout the day, some coupled with more ergonomically designed handles.

FIG. 7 shows a method of gripping one of a set of dental instruments of various sizes, as (illustrated in FIG. 1) so as to benefit from the ergonomic advantage of the varied handle size and self-contained vibration mechanism.

FIG. 8 shows a method of gripping one of a set of ergonomic dental instruments of various sizes, as (illustrated in FIG. 2) so as to benefit from the ergonomic advantage of the varied handle size and self-contained vibration mechanism.

The tip may have a flexible and durable coating 1010a coated thereon, such that the coated tip may be bent to the desired configuration. This bend may also be introduced before coating and may be present at a location coated with the DLC coating. The coating may also be present on other parts of the handle.

Heat tends to be generated about the tip during use due to frictional forces. Therefore, a coating having high lubricity can generally decrease the frictional forces and hence the heat generated, leading to reduced patient discomfort during the dental process. Suitable coatings that have high lubricity include diamond-like carbon (DLC) coatings including at least about 5 atomic percent of hydrogen. The details of durable coatings is described in a U.S. provisional patent application Ser. No. 60/612,283, entitled “Dental Tool Having A Durable Coating” filed on Sep. 21, 2004; and U.S. patent application Ser. No. 11/______, entitled “Dental Tool Having A Durable Coating” to be filed concurrently; the contents of both are hereby incorporated by reference.

Suitable coatings may include DLC coatings having, for example, between about 5 atomic percent hydrogen to about 45 atomic percent, and more for example, from about 10 to about 30 atomic percent hydrogen. Generally, higher percentages of hydrogen may be used for more flexible tips, and lower percentages of hydrogen for tips with less flexibility. Those with higher percentage of hydrogen will also be of lower density and softer than those with lower amounts of hydrogen. In addition, smaller amounts of other elements may also be present. For example, the DLCs may include up to about 5 atomic percent of oxygen or nitrogen as well as small quantities of other materials.

As noted above, the DLC coatings, though hard, may be flexible so that the flexural properties of the tip substrate will not be significantly altered by the coatings. The combined effect can be a longer lasting abrading surface.

Generally, because the DLC coatings are flexible and lubricious, a substantially uniform thickness may be achieved even at thin coatings of, for example, about 20 nm. A DLC coating may be applied substantially uniformly over a desired section of the substrate. More for example, a uniform coating may be a coating in which the thickness at all points along the substrate varies by, for example, less than about 50%, and more for example, by less than about 10% relative to the average coating thickness.

Alternatively, the DLC coating may also be applied non-uniformly so that the thickness of the coating may vary at different regions of the working surface, if desired. In some embodiments, the area with the maximum coating thickness may be no more than a factor of about two (2) thicker than the area with the minimum coating thickness. A non-uniform coating thickness can accomplish a variety of goals that a uniform coating cannot, for example, simplifying deposition, and/or adding mechanical stability to stress points of the abrading surfaces or the tip. Generally, because the DLC coatings are flexible and lubricious, a substantially uniform thickness may be achieved even at thin coatings of, for example, about 20 nm.

The DLC coating may also be thicker at portions of the tip that maybe expected to be subjected to high stress or wear to provide increased wear resistance. For example, the extended portion in the bend may have a thicker coating than the compressed portion, to keep the shape of the bend. In addition, a chosen deposition approach may inherently produce a DLC coating that is non-uniform in thickness unless significant efforts are made to reduce the non-uniformity.

The composition of a DLC coating may also be either uniform or different at different regions of the coating. For example, regions that are subject to more stress may have one particular composition while other portions of the coating may be formed with other dopants, for example, to vary the flexibility. Similarly, the DLC coating may have layers of diamond-like carbon with different compositions.

In one example, the instrument may be constructed with the tip and the hand grip already assembled prior to coating the tip with a DLC coating. This process is possible because the low coating temperature of the coating processes approximates that of autoclaving. This gives flexibility in the assembly of the insert.

FIG. 9 shows a system block diagram 900 of a dental instrument according to one embodiment of the invention. As shown in FIG. 9, the dental instrument includes a power storage reservoir such as an electrical battery 902. The electrical battery 902 is electrically coupled to a power control device 904. In an exemplary embodiment, the power control device 904 is an electrical switch such as a single pole—single throw switch. In various other embodiments, the power control device 904 may include an active device such as a transistor adapted to provide a variable output voltage in response to an operator signal, or a feedback signal 905. An output of the power control device 904 is electrically coupled to an input of a vibrational transducer 906.

According to one embodiment of the invention, the vibrational transducer 906 includes a rotary electric motor 908, such as a permanent magnet DC motor, or a stepper motor. The rotary electric motor 908 is mechanically coupled at an output shaft thereof to a dynamically unbalanced load 912 such as an eccentric flywheel. The rotation of the dynamically unbalanced load 912 by the motor acts to produce a periodic oscillatory force on the shaft of the motor 908. The periodic oscillatory force is transmitted from the shaft of the motor 908 through bearings of the motor to a housing of the motor. From the motor housing, the oscillatory force is transmitted to the housing 102 of the instrument (as shown in FIG. 3).

According to one embodiment of the invention, the vibrational transducer 906 may produce vibrations in a range from about 10 Hz to about 10 KHz. Other frequencies, including harmonics, may be achievable, depending on the characteristics of a particular system.

According to another embodiment of the invention, the vibrational transducer 906 includes a linear motor such as a solenoid, a piezoelectric transducer or a linear stepper motor.

In a further aspect of the invention, the vibrational transducer 906 is mechanically coupled to a first end of a coupling member 914. The coupling member 914 may be a discrete mechanical member, or maybe integral with the housing portion 102 (as shown in FIG. 3).

The coupling member 914 is coupled at a second end to a tooth contacting portion 104. The tooth contacting portion 104 may be, for example, a scaler tip (as shown in FIG. 2).

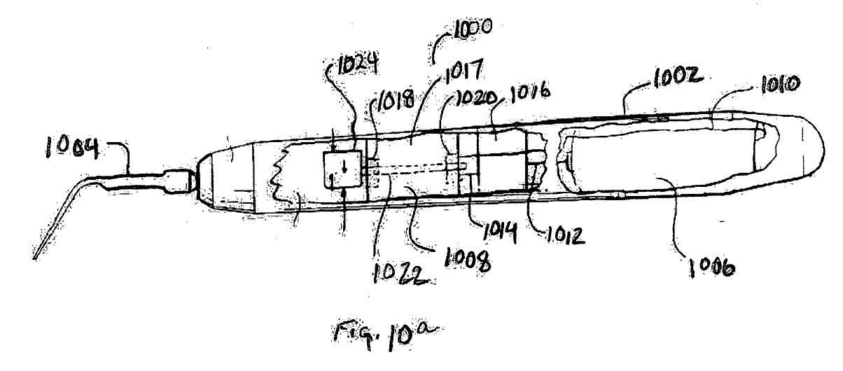

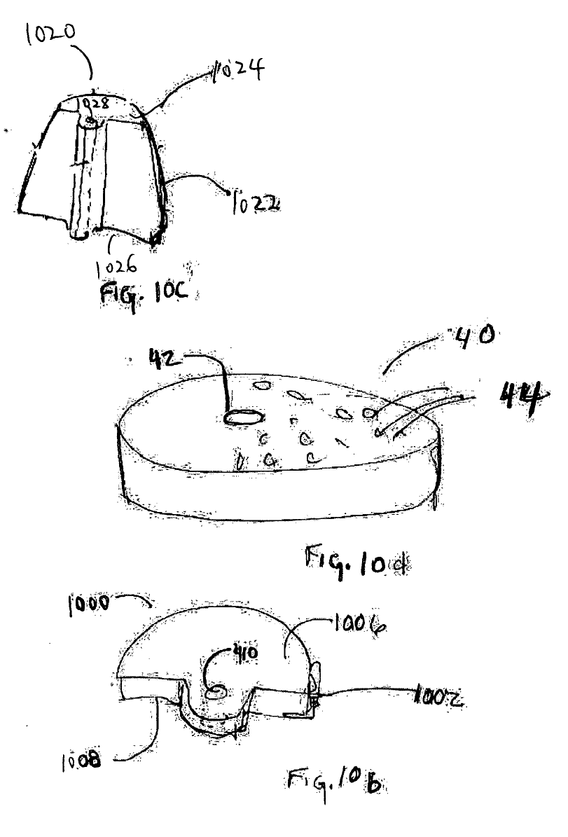

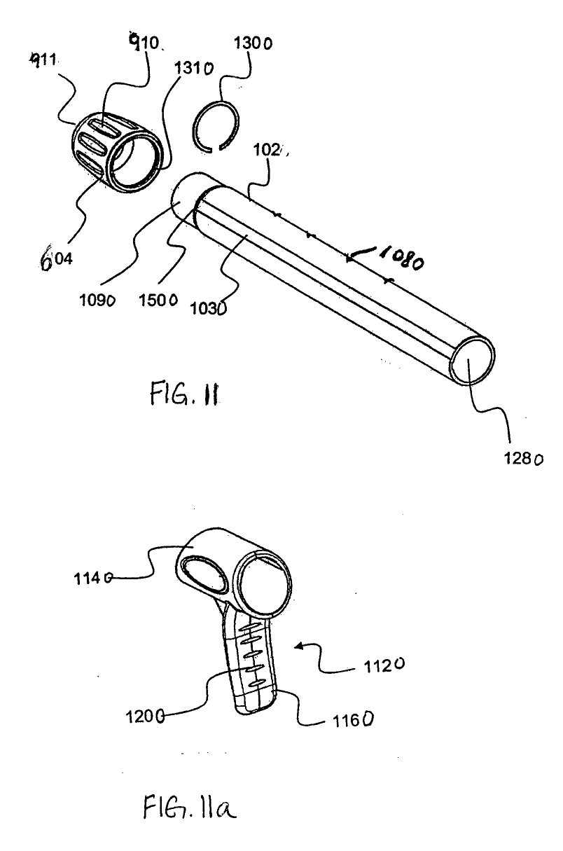

FIG. 10a is a cutaway view of a dental instrument 1000 according to one embodiment of the invention. As shown in FIG. 10a, the dental instrument 1000 includes a housing 1002 and a tooth contacting portion such as a scaler tip 1004. According to one embodiment of the invention, the housing 1002 includes an internal cavity 1002 within which is disposed a battery 1006 and an electric motor 1008. The battery 1006 is electrically coupled to the motor 1008 by electrical conductors 1010, 1012, 1014 and a switch 1016. According to one embodiment of the invention, the motor 1008 includes a housing 1017 and first 1018 and second 1020 bearings. The motor 1008 also includes a shaft 1022 rotatably supported by the first 1018 and second 1020 bearings. At one end, the shaft 1022 is coupled, to an eccentric load 1024.

FIG. 10b shows an eccentric load 1000 according to one embodiment of the invention. The eccentric load includes a mass having an arcuate circumferential surface 1002 disposed between first 1006 and second 1008 substantially planar side surfaces. A substantially cylindrical inner surface 1010 is disposed between the first and second substantially planar surfaces to define a bore having a longitudinal axis. The longitudinal axis is disposed in substantially parallel spaced relation to an axis of rotation through the center of mass of the eccentric load 1000.

In a further embodiment, as shown in FIG. 10c, the eccentric load 1020 includes a truncated section of a conical surface 1022 disposed between first 1024 and second 1026 substantially planar side surfaces. A substantially cylindrical inner surface 1028 is disposed between the first and second substantially planar surfaces to define a bore having a longitudinal axis. The longitudinal axis is disposed in substantially parallel spaced relation to an axis of rotation through the center of mass of the eccentric load. The resulting conical shape of the FIG. 10c eccentric load 1020 is an eccentric load having a mass that diminishes linearly as a function of distance along the motor shaft away from the motor.

In a still further embodiment, as shown in FIG. 10d, the eccentric load 1030 includes a truncated section of an ellipsoidal surface 1032 disposed between first and second substantially planar side surfaces. The resulting ellipsoidal shape of the FIG. 10d eccentric load 1030 results in an eccentric load having a mass that diminishes non-linearly as a function of distance along the motor shaft away from the motor.

In yet another embodiment the elliptical load includes a wheel that is substantially spatially symmetric. However the distribution of mass within the substantially spatially symmetric volume is skewed to produce a dynamically unbalanced load. According to one embodiment, as shown in FIG. 10e, the skewed distribution of mass is produced by forming the wheel 1040 of a first material 1042 and embedding particles of a second material 1044 in a spatially non-uniform distribution within first material.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A set of identical dental instruments comprising handles with varying diameters for grasping, said instruments are designed for used interchangeably throughout the day by a dental professional to decrease the repetitive grasping action through the change of grasp.

2. The dental instruments of claim 1 wherein said handle is formed as a portion of an elongated housing having an interior that is solid, hollow or partially solid, with a distal end and a proximal end, and at least one dental tip extends therefrom, and connects to one end of the housing.

3. The dental instruments of claim 2 wherein said at least one dental tip is removably connected to one end of the housing.

4. The dental instruments of claim 3 wherein said dental tip is selected from the group consisting of a dental scalar tip, an endodontic file, a dental file, a reamer, and a dental bur.

5. The dental instruments of claim 1 wherein said handle is of an ergonomic design.

6. The dental instruments of claim 5 wherein at least the portion of the handle for grasping has a triangular cross-section.

7. The dental instrument of claim 1 wherein at least a portion of said handle comprises bumps, striations, a hand grip or combinations thereof.

8. The dental instrument of claim 2 wherein said at least a portion of said housing not designed for grasping by the user has a smaller diameter than the portions used for grasping.

9. The dental instruments of claim 2 wherein said housing is tapered towards at least one end.

10. The dental instruments of claim 9 wherein said tapered end comprises a structure selected from the group consisting of a cone-shaped portion, a collar and combinations thereof.

11. The dental instruments of claim 10 wherein said structure is integrally formed as part of the housing.

12. The dental instruments of claim 10 wherein said structure is attached to the housing.

13. The dental instruments of claim 12 wherein said attachment is permanent or removable.

14. The dental instruments of claim 10 wherein said structure comprises a rotation mechanism.

15. The dental instrument of claim 2 further comprising a vibratory module positioned and supported inside the housing.

16. The dental instrument of claim 15 wherein said vibratory module comprising a small motor for rotating an eccentric weight to cause a vibration in the instrument.

17. The dental instrument of claim 16 wherein said vibratory module is powered by a power supply selected from the group consisting of a battery, a fuel cell, a solar cell and combinations thereof.

18. The dental instrument of claim 1 wherein at least a portion of said instrument comprises a coating comprising a diamond-like carbon coating comprising at least about 5 atomic percent of hydrogen.

19. Sets of dental instruments comprising handles having varying diameters, each of said handles is formed as part of an elongated housing comprising a distal end, a proximal end, and at least a partially hollow interior, wherein at least a portion of the handle for grasping has a triangular cross-section.

20. The instruments of claim 19 comprising at least one tapered end.

21. The instruments of claim 20 wherein said tapered end comprises a structure selected from the group consisting of a cone-shaped portion, a collar and combinations thereof.

22. The instruments of claim 21 wherein said structure comprises a rotation mechanism.

23. The dental instruments of claim 22 wherein when the mechanism rotates the structure it also rotates the tip.

24. The dental instruments of claim 19 further comprising a vibratory module positioned and supported inside the housing.

25. The dental instrument of claim 24 wherein said vibratory module comprising a small motor for rotating an eccentric weight to cause a vibration in the instrument.

26. The dental instrument of claim 24 wherein said vibratory module is powered by a power supply selected from the group consisting of a battery, a fuel cell, a solar cell and combinations thereof.

27. A set of identical dental instruments comprising:
handles of with varying diameters for grasping, said handle is formed as a portion of an elongated housing having an interior that is solid, hollow or partially solid, with a distal end and a proximal end;
at least one dental tip extends therefrom, and removably connects to one end of the housing;
at least one vibratory module positioned and supported inside the housing; and
at least one internal power source positioned and supported inside the housing to provide electrical power to said vibrator module.

28. The dental instrument of claim 27 wherein said vibratory module comprises a small motor for rotating an eccentric weight to cause a vibration in the instrument.

29. The dental instrument of claim 27 further comprising an anti-rotation means for preventing said vibrator module from rotating relative to said housing when said vibratory tool is in used.

30. The dental instrument of claim 27 wherein at least a portion of said instrument comprises a coating comprising a diamond-like carbon coating comprising at least about 5 atomic percent of hydrogen.
